(19) United States
(12) Patent Application Publication
(10) Pub. No.: US 2024/0265001 A1
(43) Pub. Date: Aug. 8, 2024

(54) SYSTEM AND METHOD FOR BLOCKCHAIN DATA FABRIC

(71) Applicant: Reza Fatahi, Encino, CA (US)

(72) Inventor: Reza Fatahi, Encino, CA (US)

(21) Appl. No.: 18/105,867

(22) Filed: Feb. 5, 2023

(51) Int. Cl. G06F 16/23; G06F 16/27

(52) U.S. Cl. CPC G06F 16/2379; G06F 16/27

(57) ABSTRACT

The patent application describes a system for interfacing edge computing gateways and/or databases with a blockchain data fabric infrastructure. The system, referred to as the “universal adapter”, performs computations based on data stored and accessible by the blockchain data fabric. The universal adapter comprises of at least one web3 client for communication with the blockchain, at least one peer-to-peer network storage interface, such as an IPFS client, a library of connectors to leading edge gateways and pubsub brokers, and a library of connectors to leading databases commonly found in existing or legacy data fabrics. The patent claims the novel or custom method for performing the computations in the blockchain data fabric system. Additionally, the claims describe the use of the universal adapter in the system, as well as the composition of the universal adapter itself.

### FIELD OF THE INVENTION

The present invention relates to the field of decentralized data management and information technology, specifically to a system and method for integrating and securely storing data across a network of devices using blockchain technology.

The invention is a blockchain data fabric system that provides a secure and decentralized way to manage data by integrating and storing data from various devices on a network. The system utilizes blockchain technology to provide a tamper-proof and transparent method for managing data, ensuring data reliability and reducing the risk of data breaches. The system is comprised of various components including edge devices, edge computing gateways, and a web3 client. The system allows for the creation and management of smart contracts, enabling the secure and efficient exchange of data between devices on the network.

The invention also includes a method for implementing the blockchain data fabric system, which includes steps such as device registration, data ingestion, and smart contract creation and execution. The method ensures secure data transfer and storage by utilizing cryptographic techniques and consensus mechanisms. The invention also provides a graphical user interface for configuring and managing the blockchain data fabric system.

Current data management systems are often centralized and can become overwhelmed with the sheer volume of data. This can result in slow performance and a risk of data loss or corruption. The present invention provides a secure and decentralized way to manage data on a network of devices, utilizing blockchain technology to ensure data reliability and reduce the risk of data breaches.

### BACKGROUND

IoT and embedded device execution environments have become ubiquitous in the modern world. For example, interactions from a remote sensor in a warehouse or a mobile device or sensor in a supply chain operation may transmit data to a remote edge gateway at a rapid rate. When this occurs from many sources, such as in complex networks, it creates challenges to ensure data integrity and organizing analyses of related processes.

To address these challenges, a new type of data management system has emerged, known as data fabrics. Data fabrics are designed to provide a decentralized and scalable solution for data management. Unlike traditional systems, data fabrics distribute data across a network of nodes, allowing for faster access and improved reliability.

However, there are still challenges with data reliability and security in data fabrics. With the decentralized nature of data fabrics, there is a risk of data being lost or corrupted if a node fails. Additionally, there is a need for a secure and efficient way to manage access to the data stored in data fabrics.

Data reliability is crucial in data fabrics as it affects the accuracy and integrity of the information used for critical decision making. The data fabric must ensure that the data it stores, and processes is complete, accurate, and consistent. Additionally, the ability to process and analyze large amounts of data in a timely and efficient manner is essential for making informed and effective decisions. The present invention provides a solution to these challenges by introducing a blockchain-based data fabric platform.

### BRIEF SUMMARY

Disclosed implementations provide executable models, specifically embedded device models that can be interfaced according to their relationships with other structures, devices, and processes for use in various data fabric applications and deployments. By coupling a model with a maximally efficient and strictly defined interface definition, the models of the system behave in a uniform manner that allows their ability to be queried and analyzed to assist decision-making processes. The composite data structure representing the model is referred to as a “graphical unit” herein. The collection of graphical units and their uniform interface allows for the automation of data fabric infrastructure services, such as fault tolerance, auto-repair capabilities, data integrity measures, security, scalability, and reliability, while retaining the ability to analyze and create deep complex queries against the data.

An aspect of the invention is a graphical data structure that enables the discovery and formation of deep links for queries of data stored on blockchain and smart contract platforms, particularly data from remote embedded devices within a data fabric. The data fabric is composed of an edge computing gateway and the graphical data structure includes: a device model that is executable by a computer processor to perform computations on the data in accordance with a computation model; an interface definition with a connection to an autonomous, low-code, or no-code system, which automates or semi-automates changes relating to the creation, management, and removal of smart contract interface definitions, translated to blockchain-specific languages; a non-fungible token that is defined from a templated and minimal set of strict interface definitions in intermediate representation, and; a universal adapter that links edge computing devices and their data to the systems of the blockchain data fabric infrastructure, composed of at least one blockchain and one non-transitory peer-to-peer storage. The universal adapter includes at least one connection to an edge computing gateway, such as a pubsub broker, and may also include a connection to an existing or legacy database.

The universal adapter is claimed as another aspect of the invention. The key aspect of the universal adapter is its ability to interface with leading edge computing gateways such as MQTT, Kafka, and others, and optionally to interface with existing or legacy databases. This adapter would allow for the integration of the blockchain network with other systems and services, providing a seamless and flexible solution for data management and analysis. The universal adapter is an important component of the overall deployment of the blockchain network and parallel peer-to-peer storage strategy, further expanding its capabilities and potential use cases.

The final remaining aspect is a method for cloud-native deployment of a blockchain and parallel peer-to-peer storage components, such as IPFS, using containerization techniques, and using a low or no-code interface to configure and manage the network through container orchestration tools. This will allow for a flexible and scalable deployment of the blockchain data fabric infrastructure, providing a cloud-native solution to the deployment and management of the network. The cloud-native deployment of the blockchain leverages the scalability, reliability, and resiliency benefits inherent in cloud computing, enabling the network to be highly available and responsive to changing demands. The low or no-code interface used to generate code that represents the configurations, adaptations, and changes to the network, ensures that the deployment is streamlined, flexible, and easy to manage. Additionally, the parallel peer-to-peer storage strategy, such as IPFS, provides a decentralized and resilient data storage solution, ensuring that data stored in the blockchain is secure, readily available, and can be easily accessed and shared by authorized users.

### BRIEF DESCRIPTION OF THE DRAWING

The foregoing summary, as well as the following detailed description of the invention, will be better understood when read in conjunction with the appended drawings. For illustrating the invention, these are shown in the drawings' various illustrative embodiments. It should be understood, however, that the invention is not limited to the precise arrangements and instrumentalities shown. In the drawings:

FIG. 1 is a schematic illustration of the structure of a graphical unit of operation in accordance with the disclosed implementations.

FIG. 2 is a schematic illustration of data acquisition and management by the universal adapter in accordance with the disclosed implementations.

FIG. 3 is an alternate embodiment of data acquisition and management in a hybrid database and blockchain environment, as may be found upon installation in a legacy system in accordance with the disclosed implementations.

FIG. 4 is pseudocode representation of one embodiment of the universal adapter in accordance with the disclosed implementations

FIG. 5 is a representation of one embodiment of the minimal ERC721 smart contract template.

FIG. 6 is a schematic illustration of the aspects of the low/no-code interface and blockchain data fabric infrastructure, in accordance with the disclosed implementations.

FIG. 7 is a schematic illustration of an alternate embodiment of the components of the low/no-code interface in accordance with disclosed implementations.

FIG. 8 is a schematic illustration of the deployment workflow of a blockchain data fabric infrastructure in accordance with the disclosed implementations.

### DETAILED DESCRIPTION

Certain terminology is used in the following description for convenience only and is not limiting. Unless specifically set forth herein, the terms “a,” “an” and “the” are not limited to one element but instead should be read as meaning “at least one.” The terminology includes the words noted above, derivatives thereof and words of similar import.

The primary embodiment is a data fabric platform for embedded devices. It is common to refer to the point at which a sensor or IoT/embedded device connects to a network as the “edge” or “edge computing”. The edge computing platform can act as an interface for these devices to connect to, and sometimes it is also referred to as an “edge gateway”. A publication-subscription (PubSub) broker can also be used in this context, to manage communication between the devices and other parts of the network. The exact terminology used can depend on the specific context and technology stack and may vary. The edge can vary in different ways, including type, technology, protocol, and others. It may not always be at the same network layer, as it depends on the specific implementation and requirements of the network. For example, in some cases, the edge may be at the physical layer, while in others, it may be at the application layer. The exact definition of the edge in a network can vary depending on the specific context and application.

The primary embodiment is intended to connect to edge computing can theoretically connect to various edge devices that operate at varying network layers that then collects, organized, and sends values for storage in a blockchain. Blockchain technology can be considered a network communication layer in the sense that it provides a secure and decentralized means of exchanging data between different participants in a network. In a blockchain, data is recorded and stored in blocks that are linked and secured using cryptography. Each block contains a unique cryptographic hash of the previous block, creating a chain of blocks that cannot be altered retroactively. This provides a secure and tamper-proof ledger of data transactions, making it an attractive option for applications where high-assurance and high-reliability are required.

Blockchain records can be queried and the primary embodiment of the present solution purposes blockchain as a secure and scalable long-term query-able store of sensor data and relationships as an advancement to data fabric layers. The query process varies depending on the specific blockchain technology and the data storage method used (e.g., a distributed ledger, a database, etc.). However, in general, blockchains are designed to allow for data retrieval and to provide a secure and transparent way to access information stored in the blockchain.

To protect data in a blockchain and allow queries only when permitted, the use of smart contracts and access control mechanisms are included in the primary embodiment. The smart contract can define the rules for accessing the data, such as requiring specific permissions or authentication before allowing a query. Access control mechanisms can also be used to enforce these rules and ensure that only authorized entities are able to access the data.

ERC721 is a Non-Fungible Token (NFT) standard used on the Ethereum blockchain that can be readily applied, as a standard, across many other blockchain decentralized computing systems such as NEAR, Tezos, Oasis Rose, and others. The standard allows the creation of unique digital assets that can represent anything, including data associations and access control mechanisms of data from remote embedded devices, as in the primary embodiment. By implementing ERC721 in smart contracts, the primary embodiment creates secure and programmable data associations and control who can access and modify the data. This can be used to protect sensitive data and ensure that only authorized entities can access and query it, while also allowing rich queries relating to data and/or device association, combination, arrangement, permutation, recombination, etc. that may be used for analysis and decision-making purposes.

Data in a blockchain can be linked in a graph by using graph data structures such as un/directed a/cyclic graphs and property graphs. In these structures, nodes represent entities and edges represent relationships between entities. The data is stored in blocks, and the relationships between the blocks can be modeled as edges in a graph. This allows for complex relationships to be represented and queried in a decentralized and secure manner. The implementation of a graph-based structure can be added on top of a blockchain network as a layer of abstraction, or built into the core of the blockchain itself, depending on the specific use case and requirements of the system.

ERC721 is a standard for creating unique, NFTs on various blockchains. The ERC721 standard is a general decentralized computing standard and is not specific to the Ethereum blockchain. It can be implemented on any blockchain that supports smart contracts and can be used for creating NFTs on any such blockchain. The ERC721 standard can be used to create a/cyclic and/or property graphs by creating a token for each node in the graph, and then using token metadata to specify relationships between the nodes. For example, one could create a token for an external sensor, another token for an internal sensor, where the external factors measured directly impact the status of the internal component and use the metadata on the external device token to specify the value of the internal component, and vice versa. In this way, ERC721 can be used to represent a graph of connected nodes, with each node being represented by a unique token.

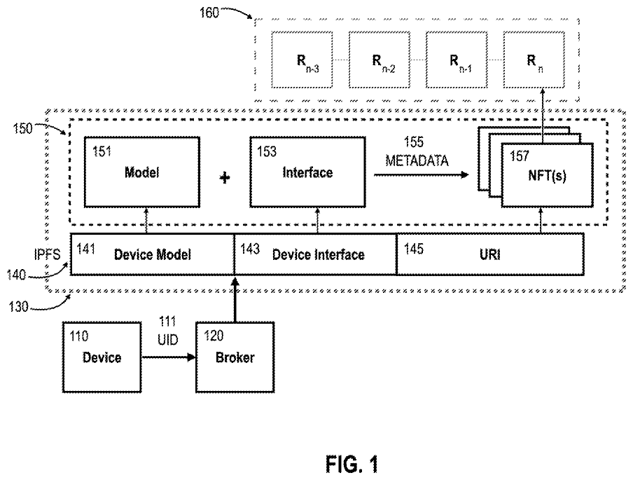

FIG. 1 illustrates the overview of the primary embodiment in accordance with the disclosed implementation. An embedded device 110 that represents a local or remote device, such as an IoT sensor or PLC controller, communicates with a unique identifier 111 to an edge device such as a PubSub broker 120. The device carries a signal, value, data, payload, or other transmittable form of a bytestream representation of another physical or digital process, such as measuring temperature for a temperature sensor. Furthermore, the device is configured to communicate with the edge computing device, in advance, as a separate process. Therefore, the primary embodiment in accordance with the disclosed implementation is intended to interface with new or existing deployments of embedded devices and their networks.

As illustrated in FIG. 1, the primary embodiment consists of a blockchain deployment 130 that is comprised of at least one decentralized and/or distributed long-term storage 140, such as Inter-Planetary File System (IPFS), and at least one blockchain network that is capable of decentralized and/or distributed computing tasks in accordance with the disclosed implementation.

Within the decentralized and/or distributed long-term storage 140, a representation of the device 141 and its interface(s) 142 exist as separate or independent data structures. This allows for flexibility in representing and organizing data in a way that suits the specific needs of the application. The device and its interface can be stored and managed in different data structures, and the relationships between them can be defined as necessary. This helps simplify the data management process and improve data organization and accessibility.

Once a device is interfacing with its corresponding edge computing gateway 120, the corresponding payload is obtained and stored in long-term storage 145. Thereafter, the data becomes available from a Uniform Resource Identifier (URI) 145 for use elsewhere.

The corresponding blockchain deployment is a “smart contract platform” 150, since the deployment and primary embodiment primarily rely on executing smart contracts, specifically the standard and interfaces of ERC721. In general, the ERC721 standard defines a minimal set of functions for token contract implementations to ensure compatibility with various smart contracts platforms and applications. Therefore, the standard allows communication across blockchain protocols, frameworks, systems, and networks. The minimal set of characteristics of the ERC721 standard are comprised of at least the following six features:
Unique identifier: Each token in the system must have a unique identifier, allowing it to be distinguished from other tokens.
Token owner: The owner of a token may define privileges for read and write access to the individual token, including transactions of the token.
Supports transfer: The token must be transferable to another address, allowing the owner to transact from one address to another, such as may be used to move records to cold storage, for example.
Supports metadata: Token metadata contain the graphical unit associated with the device model represented by the token, and also a pointer to the data records of the device and associated devices, if any.
Supports events: Tokens must support events, allows tracking of token changes and designated or defined events, as made available by the low/no-code interface.
Supports approvals: Tokens must support approvals, allowing for proxy operations such as managed transfers and other transactions.

The primary embodiment in accordance with the disclosed implementations is a blockchain data fabric platform 130 consisting of at least one interconnected device 110 and gateway 120 that facilitate communication and transfer of data within the network. A device communicates with an edge computing gateway by way of its unique identifier 111 and payload, which are transmitted by the gateway or broker 120 to the blockchain data fabric platform 130. This unique identifier serves as the device's identifier within the network and is used to interact with web3 clients that manage smart contract operations.

The payload is the data generated and/or transmitted by the device, which can be a measurement, a reading, a status update, or any other relevant information. This payload is transmitted to the edge computing gateway, which then makes API calls to the web3 client using the device's unique identifier and the payload as input.

The web3 client, acting as an interface to the blockchain network, uses the device's identifier to perform smart contract operations, such as reading or writing data to the blockchain, executing transactions, or querying the blockchain for specific data. This data can then be used by various applications and services connected to the blockchain data fabric platform. In this way, the unique identifier and payload, along with the web3 client and smart contract operations, form the foundation of communication and data transfer within the blockchain data fabric platform.

In the primary embodiment illustrated in FIG. 1, the web3 client can create graphical relationships between the data and payload of the device by using intermediate structures that represent the device as a model 151 and the interface as a model 153. This allows for the creation of a graphical representation of the device and its interface, which can be used to perform various smart contract operations on the blockchain network including complex queries.

The graphical relationships are associated with the smart contract as metadata 155, as they provide additional information and context about entities represented in a graph data structure. In the primary embodiment, the forms of graph data structures include, and not limited to, the most basic and commonly used graph data structures:
Directed Cyclic Graphs (DCG): a type of graph where vertices are connected by directed edges, forming a cycle or loops.
Undirected Cyclic Graphs (UCG): a type of graph where vertices are connected by undirected edges, forming a cycle or loops.
Directed Acyclic Graphs (DAG): a type of graph where vertices are connected by directed edges, with no cycles or loops.
Undirected Acyclic Graphs (UAG): a type of graph where vertices are connected by undirected edges, with no cycles or loops.
Graph Properties: graph properties refer to the characteristics of a graph, such as size, degree, connectedness, cycle structure, etc.

In the primary embodiment, the result of the data and metadata against a smart contract is results in an NFT 157 that represents a unique and indivisible asset, embedded device. A single NFT 157 can contain the graphical relationships and data associated with a device model and its interface, and it is possible to dynamically update or change the associations and parameters of the device model in a smart contract.

Alternatively, the representation of a device model and its interface can also be represented as a collection of multiple NFTs 157. The pros or cons of querying a single NFT versus multiple NFTs in a blockchain for determining relationships between records depends on the specific requirements and use cases of the application.

Querying a single NFT can simplify the data structure and reduce the complexity of querying relationships between records, but it may also result in larger and more complex NFTs. Querying multiple NFTs can increase the complexity of querying relationships between records, but it can also provide more flexibility and scalability in managing the data structure and relationships between records.

When querying NFTs in a blockchain, queries are typically made against specific NFT contract types 160, not against all NFTs. For example, you can query NFTs by using the contract address and the token identifier of the NFT. This is because NFTs are created and managed by smart contracts, and each NFT contract type has a unique structure and set of attributes.

In another embodiment, a collection of multiple NFTs representing various relationships of one device to another device or parameter are queried by using the data stored in the NFTs or by using additional data structures in long-term storage 140. The present invention is not intended to be limited to either type of metadata organization and query strategy, both are the result of a shared underlying strategy for the organization and maintenance of records and assets as a data fabric for complex embedded device networks. Therefore, the primary embodiment is intended to support the application of single-contract relationships and queries, as well as multiple-contract relationships and queries, to organize the NFTs for complex query capabilities based on the specific use case and the requirements for performance, scalability, and security.

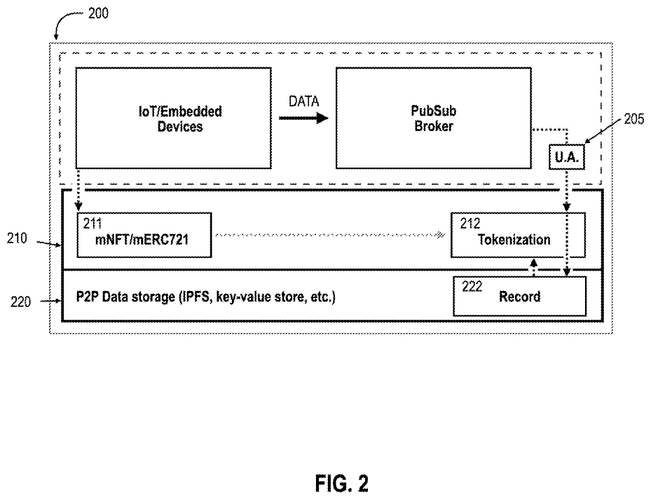

The illustration of FIG. 2 represents the blockchain data fabric platform 200 wherein records are exclusively maintained by the blockchain network 210 and its corresponding decentralized and/or distributed long-term data storage 220. The operations of the primary embodiment are enabled by a Universal Adapter 205 that links the at least one edge computing gateway with a corresponding web3 client of the blockchain network 220.

The method of the primary embodiment consists of a smart contract representing the minimal set of methods and/or interfaces of the ERC721 standard 211 that is represented as a minimal-NFT or minimal-ERC721 (mNFT/mERC721) smart contract capable of creating individual NFTs 212 in a form-efficient manner that is ideal for managing complex embedded device systems and networks.

The advantage of a minimal version of the smart contract standard 211 is that it can help reduce complexity, minimize potential security risks, and speed up the deployment and execution of smart contracts. The minimal version of the smart contract standard 211 is comprised of only the essential functions and features that are required for the ERC721 standard and only implementing those in the smart contract. The primary embodiment defines templates of the minimal version of the smart contract standard 211 in accordance with various blockchain smart contract languages including Solidity, Vyper, Rust, and others.

In general, each implementation of the ERC721 standard is available for the various blockchain and smart contract platforms. The creation of their corresponding minimal version of the smart contract standard 211 involves a process of simplifying the code, removing unnecessary elements, and focusing on the core functionality that is required to achieve the intended purpose. This can also involve reviewing the data structures and variables used, ensuring that they are properly optimized and that only the minimal necessary information is stored on-chain. Thereafter, additional features, qualities, capabilities, and code may be added as needed, on an individual basis depending on the specific application.

The primary embodiment is not intended to be specific to any decentralized and/or distributed long-term data storage. At the time of this writing, IPFS is a leading solution. However, other existing and new options may exist, for example by configuring existing SQL or noSQL databases as a distributed computing cluster.

IPFS is a decentralized file storage system that allows for the storage and retrieval of large amounts of data in a distributed manner. It works by breaking down files into smaller blocks, which are then stored and retrieved using a content-addressable system, where each block of data is identified by its content as a record 222, rather than its location.

By using IPFS in parallel with a blockchain, the data generated by embedded devices are stored on IPFS, while the metadata, such as the relationship between devices and pointers to IPFS, could be stored on the blockchain for accessibility of advanced query features, for example. In this manner, embedded devices can transmit data at high rates in a minimal form factor that results in the optimization of blockchain performance, such as transaction processing times and computing costs.

In the primary embodiment, the blockchain is used to manage the metadata, while IPFS or another form of decentralized and/or distributed long-term storage is used to store the actual data generated by the embedded devices. This approach results in the improvement to overall performance, scalability, and efficiency of the system, as well as reduced loads on the blockchain network.

The choice between using IPFS and another peer-to-peer version of an existing or new storage solution, such as a key-value store as represented by Redis, will depend on the specific requirements and constraints of the application, as well as preferences such as data format types or structures, performance, and other considerations including costs and licensing issues.

IPFS is generally included in the primary embodiment due to its advantages of being a decentralized file storage system and handling of large amounts of unstructured data. Therefore, the data is available to be structured and organized as separate processes, resulting in maximal flexibility for deployments across many types of applications. IPFS can also be used to store and retrieve files in a distributed manner and has been shown to improve the scalability and reliability of systems.

On the other hand, an existing or emerging alternate peer-to-peer long-term storage solution, such as a key-value store represented by Redis, would be selected in other embodiments when the requirements included more structured data and higher efficiency or speed to store and retrieve the data generated by embedded devices. In this example, Redis is selected as a fast and efficient key-value store that is well-suited for real-time applications, and it provides a range of data structures and operations that can be used to manage the data generated by embedded devices.

Ultimately, the choice between IPFS and another peer-to-peer long-term storage solution will depend on the specific requirements and constraints of individual applications. The present invention is not intended to be limited in the form, type, framework, or approach of its corresponding peer-to-peer long-term storage solution.

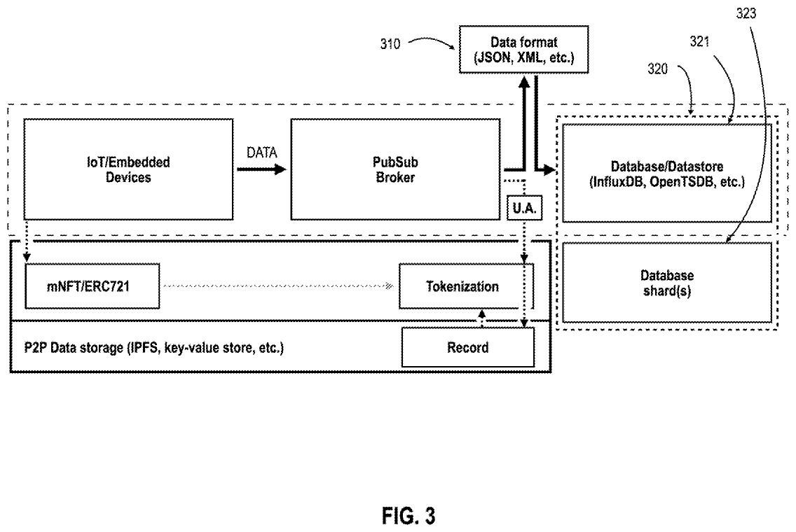

For example, FIG. 3 illustrates an example with a known or existing data structure 310 that corresponds to a specific deployment of a database or storage strategy 320. The database or storage strategy is comprised of at least one type of database or datastore 321. Optionally, it may also consist of multiple types and/or instances of at least one database, in a distributed manner, as database shards 323.

A database 321 will typically be used to store values from embedded devices in a legacy system. For example, a PLC historian will be an existing SQL database that exists as a single instance or multiple instances when redundancy and/or distributed computing is enabled. In this scenario, the primary embodiment of FIG. 3 will run alongside the existing SQL database of the historian. In another embodiment, the blockchain data fabric platform will replace the SQL database entirely.

It is important to note that the Universal Adapter 205 will also be the point of interface for existing databases. In a typical legacy data fabric architecture, the data is collected by an MQTT or PubSub-like broker such as Kafka, which acts as an intermediary between the devices and the database. The broker can handle the real-time communication and data collection from the devices, and then pass the data on to the database for storage and further processing. The database is then used to store the data in a structured format, allowing the data to be queried and analyzed.

In complex embedded device networks, there may also be large amounts of time-series data, in which case a database optimized for time-series data such as InfluxDB or OpenTSDB would be used. There are several popular databases that are commonly used for data fabric applications, some of the most popular ones include:
InfluxDB: A time-series database that is optimized for storing and querying time-series data. It is often used for monitoring and analytics applications.
OpenTSDB: An open-source time-series database that is built on top of HBase. It is designed for storing and querying large amounts of time-series data.
TimescaleDB: An open-source time-series database built on top of PostgreSQL, it is designed to handle time-series data at scale, and it also supports SQL query language.
MySQL: A widely used open-source relational database management system. It is a good choice for IoT applications that require a relational database for data storage and querying.
MongoDB: A popular open-source NoSQL database that is known for its scalability and flexibility. It is often used for storing large amounts of unstructured data.
Cassandra: A distributed NoSQL database that is designed for handling large amounts of data across multiple commodity servers. It is well suited for handling high write loads.

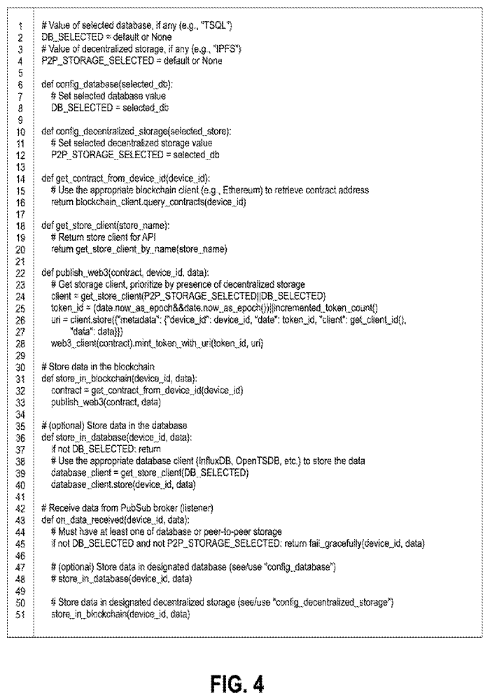

Generally, the storage operation of the Universal Adapter 205 include methods to: (i) receive a request from a user to convert an existing database or datastore connection for use in a blockchain environment; (ii) identifying the type of existing database or datastore connection; (iii) determining the appropriate blockchain protocol for the identified type of existing database or datastore connection; (iv) communicating with the identified type of existing database or datastore connection and the determined blockchain protocol; and (v) providing the user a convenient interface to create, add, or replace the long-term storage strategy of their data fabric. FIG. 4 is a pseudocode representation of the Universal Adapter 205 that contains both an interface to an edge gateway and, optionally, a legacy database or datastore interface that then may connect to multiple various databases.

The pseudocode of FIG. 4 provides a high-level representation of the steps involved in receiving, storing, and managing data from IoT devices in a data fabric platform, using a database, a blockchain, and IPFS for added security and redundancy. The code includes a handler for data received from IoT devices, which publishes the data to a PubSub broker. The broker then handles the data, storing it in both the database and the blockchain, and the blockchain communicates with IPFS for secure, decentralized storage.

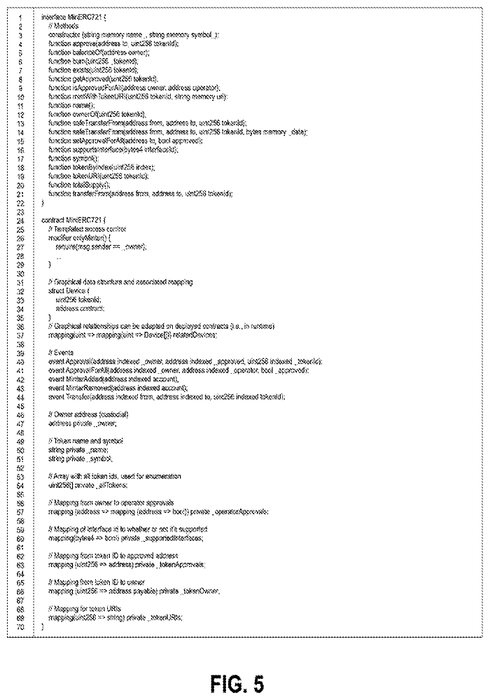

FIG. 5 is a sample implementation of one embodiment of a minimal ERC721 smart contract (mNFT/mERC721) written in Solidity. The representation in Solidity is not intended to be limiting, and the smart contract may have been represented in various other forms or languages including Flux, Vyper, and custom intermediate representations. Of significance, FIG. 5 illustrates the mappings to graphical units, displays basic access control mechanisms that may be varied by the low/no-code interface, and contains the minimal set of strict interfaces and events to meet the specifications of the standard.

In terms of the current market, the demand for data fabric platforms for embedded devices and remote procedures is growing rapidly, driven by the increasing number of connected devices and the need to manage, analyze, and make sense of the vast amounts of data generated by these devices. The state-of-the-art in the field of data fabric platforms for embedded devices and remote procedures is constantly evolving, with new solutions and approaches being developed all the time. Currently, there is a wide range of both commercial and open-source solutions available, each with its own strengths and weaknesses. Some popular commercial solutions include platforms from Amazon Web Services, Microsoft Azure, and Google Cloud. Open-source alternatives include platforms such as InfluxDB, OpenTSDB, and Apache Cassandra. The primary embodiment applies the principles of modern cloud-native computing standards and microservices to the automation of deployment and maintenance practices of a complex blockchain data fabric platform.

The purpose of the primary embodiment is not only to replace or reinforce existing databases and data fabric infrastructures. Rather, the primary embodiment is intended to reduce the complexity involved to configure and secure database deployments in legacy data fabric systems, such as a historian. For example, in operational technology environments, there may not be a database administrator or otherwise information technology support to create database shards, distribute computing, add redundancy to stop potential data loss, and to secure the environment against threats and attacks. The primary embodiment is intended to automate and alleviate these, and other similar challenges as related to an advancement of data management with the blockchain data fabric, especially as it relates to data transmissions from remote embedded devices.

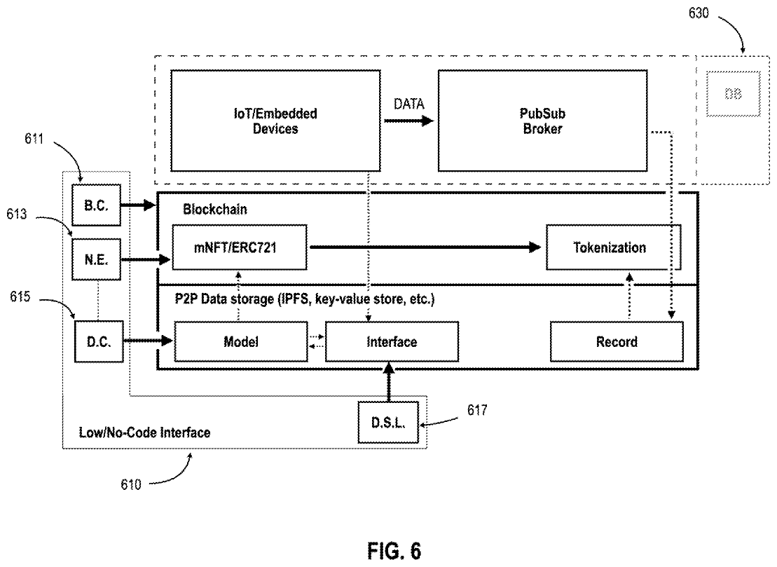

The automation of the primary embodiment exists primarily within the Universal Adapter of 205 and the Low- and/or No-Code Interface (L/NCI) of 610. FIG. 6 illustrates the aspects of the L/NCI in relation to a blockchain data fabric. The primary embodiment of the L/NCI is comprised of at least:
Blockchain Configuration (BC) 611: a form-based and/or low-code container orchestration configuration that is comprised of at least one of a combination of various technologies such as automation, scripting, and frameworks.
Node Editor (NE) 613: at least one of a block-based programming interfaces or data flow programming interfaces that is used to describe, customize, and otherwise modify the programs, interfaces, features, capabilities, and functionalities of the mNFT/mERC721 smart contract, including deployment of smart contracts.
Device Configuration (DC) 615: the interface that is used to create and/or modify the mNFT/mERC721 smart contract that represents any single embedded device or remote process or procedure.
Domain Specific Language (DSL) 617: a low-code interface that normalizes processes of the mNFT/mERC721 smart contract and generates code in multiple smart contract languages including Solidity and Flux, depending on the selected and deployed blockchain network and protocol.

The primary embodiment of the L/NCI 610 is to reduce the complexity of defining and managing complex data fabric blockchain systems. The interface 610 allows users to define their blockchain network, decentralized and/or distributed long-term storage, and to expand or modify existing networks. Additionally, the L/NCI 610 allows users to design smart contract logic, inputs, and outputs in a visual, intuitive way, including scripting solutions with a DSL interface, that then generates the corresponding NFT smart contract code for deployment to a specific and designated blockchain network, comprised of at least one blockchain network.

The primary embodiment of this system can be used to create new data fabric infrastructure, replace existing data fabric infrastructures, and to harden existing data fabric infrastructures. In the latter case, a legacy database system 630 will be present that will continue to operate in parallel to the data fabric blockchain platform of the primary embodiment in accordance with the disclosed implementations.

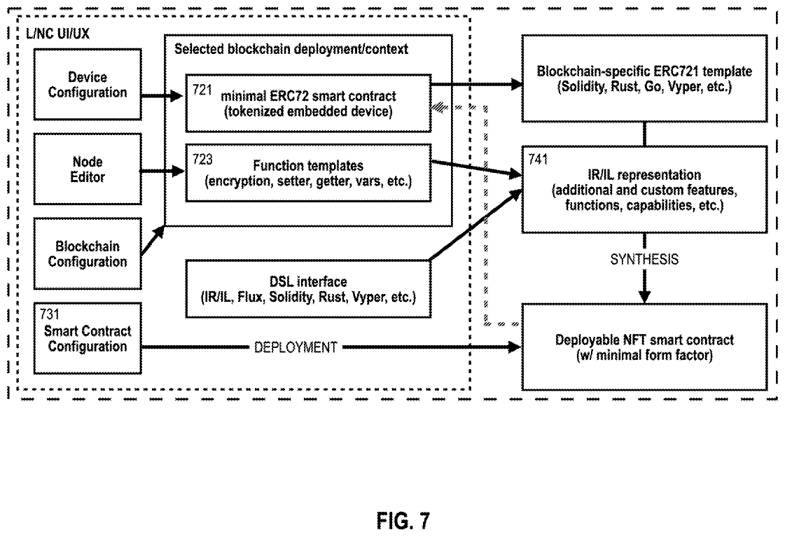

FIG. 7 is an alternate workflow depiction of the L/NCI 610 that shows its components and related downstream processes. The Device Configuration 615 results in the tokenization of an embedded device as a mNFT/mERC721 smart contract interface for the creation of NFTs 721. A lifetime can be set according to rules that can be set to make management of records easier, such as by creating a new mNFT/mERC721 interface on a monthly basis and organizing the contracts by their month and year of operations for queries at a later date. The present embodiment is not intended to limit the actual strategies and functions of how smart contracts are used. Additionally, dynamic changes to the mNFT/mERC721 interface of an embedded device or remote procedure may exist with the Device Configuration, such as capabilities to bind the actions, events, and/or data of at least one other embedded device, remote procedure, and mNFT/mERC721 interface.

The Node Editor 613 is the low/no-code interface to the Device Configuration 615 and allows users to create, configure, and manage features and capabilities from the selection of function templates, definition of variables (i.e., with their respective getters and setters), and pre-built features such as encryption that are available in at least one of a drag-and-drop interface, visual editor, or other intuitive interface that requires no knowledge or expertise in writing computer programs 723. There are several examples of low/no-code platforms that provide an easier and more user-friendly way to develop smart contracts, without requiring extensive programming skills or a deep understanding of the underlying blockchain technology. Some of the most popular low/no-code platforms for smart contract development include:
Blocklet: A low-code platform that provides an intuitive drag-and-drop interface for building smart contracts, allowing developers to easily create and deploy contracts without writing any code.
NEXO: A no-code platform that allows users to create smart contracts and deploy them on the Ethereum network, without requiring any programming skills.
OpenZeppelin: An open-source platform that provides a library of pre-built, secure, and tested smart contract components, which developers can use as building blocks for their own contracts.
Gnosis: A low-code platform that provides a visual interface for designing and deploying smart contracts, allowing developers to focus on the business logic rather than the technical details of blockchain technology.
Aragon: An open-source platform that provides a user-friendly interface for creating and managing decentralized organizations, allowing developers to create and deploy smart contracts without writing any code.

These low/no-code platforms provide a simpler and more accessible way for users to create and deploy smart contracts, helping to lower the barrier to entry and increase the adoption of blockchain technology.

By using the Node Editor 613, the primary embodiment streamlines the customization, modification, management, and creation of smart contracts by eliminating the need for manual coding and focusing on the defining logic and functionality of the ERC721 smart contract in a pre-optimized form as an mNFT/mERC721 smart contract interface. Additionally, the Node Editor 613 increases the speed of development and make it easier for non-technical users to participate in the process.

The Blockchain Configuration 611 is an interface for configuring a blockchain network deployment in a cloud-native or Kubernetes-like manner that uses containers. The approach for setting up this interface involves the orchestration of containers that contain all the necessary components for running a blockchain network. These components include at least the blockchain software, the consensus mechanism, and the network configuration.

The containers are deployed and managed using standard cloud-native tools like Kubernetes. The primary embodiment includes a Blockchain Configuration 611 that simplifies the management of containers and networks, allowing users to create, start, stop, modify, and destroy blockchain networks as needed. Additionally, the interface allows users to monitor the network, view performance metrics, and ensure that the network is running smoothly.

The advantage of this approach is that it provides a high degree of flexibility and control over the deployment, allowing users to quickly respond to changes in the environment and to automate responses, such as by utilizing reinforcement learning and deep learning algorithms. Additionally, the primary embodiment simplifies the management, deployment, and monitoring of blockchain data fabric networks, providing a clear view of what is happening and helping users to resolve any issues that may arise.

The Blockchain Configuration 611 is a combination of automation, scripting, and frameworks. For example, the use of containers, like cloud native or Kubernetes deployments, fall under the automation aspect. Other popular open-source solutions for automating the deployment, scaling, and management/orchestration of containerized applications include Docker Swarm, Apache Mesos, Hashicorp Nomad, Amazon ECS (Amazon Elastic Container Service), Red Hat OpenShift, and Rancher.

The Blockchain Configuration 611 also provides full control over the blockchain network, including the supply of native tokens. Although there is a default value for the number of native tokens to have in the genesis block, which is the first block in the blockchain, this and other aspects are available for overriding default configurations. By allowing users to control the supply of native tokens, it makes it possible for various embodiments to exist whereby the application is controlled, at least in part, by the supply of native tokens.

Blockchains have a fixed supply of native tokens, required for performing transactions on the network, and the total supply is partly determined at its creation. When deploying a blockchain locally, users would only have control over the nodes in the local network and may not be able to create or modify the total supply of ETH. The blockchains may be based on the proof-of-work (PoW) consensus algorithm, which involves validators (miners) competing to solve complex mathematical problems to validate transactions and add blocks to the blockchain, for which they are rewarded with newly minted native tokens over time until it reaches its final supply. Blockchains may also be based on other consensus algorithms such as Proof of Stake (POS) that allows validators to create new blocks and validate transactions in the network in exchange for a reward. In a POS system, validators must hold a minimum number of native tokens in their accounts to participate in the validation process, a process known as staking. With PoS, new blocks are created through a random selection of validators who then validate transactions and add them to the blockchain.

In terms of ensuring a reliable supply of native tokens, the primary embodiment in accordance with the disclosed implementations pre-fund the network with a sufficient amount of native tokens to cover the costs of running the network over a long period of time, and implementing a PoW and/or PoS consensus mechanism that incentivizes participants to continue participating in the network by providing rewards in the form of creating an additional and running supply of native tokens. In this manner, the primary embodiment eliminates the challenges of creating and managing long running blockchain networks.

Other aspects of the L/NCI 610 include the Smart Contract Configuration 731 that represents the runtime representation, features, and functionalities of the smart contract result from other aspects, namely the Node Editor 613 and Device Configuration 615. This aspect is responsible for deploying and updating smart contracts on chain.

Another aspect of the L/NCI 610 is the Domain Specific Language (DSL) 617. Together with other aspects, such as the Node Editor 613, the products, value, or data are represented in intermediate form as Intermediate Representation (IR) or Intermediate Language (IL) 741. The IR or IL representation, in combination with blockchain-specific mNFT/mERC721 smart contract templates, results in the formation of blockchain- and language-specific implementations, customizations, capabilities, and features of a final mNFT/mERC721 smart contract interface that is available for deployment. Note, the access of runtime modification capabilities, modifying the smart contract on chain, by the Device Configuration 615. It is important to point out that changes resulting from the Device Configuration 615 will relate to referenced information or data available in long-term storage, whereas changes resulting from the Smart Contract Configuration 731 result in on-chain changes. However, the present embodiment is not intended to limit or exclude these features that may otherwise be combined or compounded to fewer components, where there are at least four components that comprise the L/NCI 610.

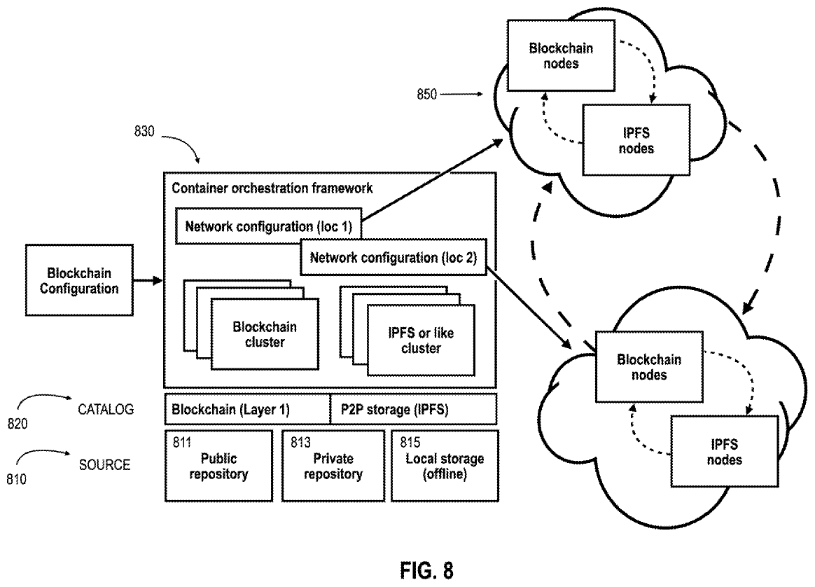

In FIG. 8, the workflow diagram of a blockchain network deployment is illustrated. The Blockchain Configuration 611 references a source 810 from at least one of a public repository, private repository, or local storage, such as a local container registry or file system. The source 810 represents a catalog 820 of selections for at least one of a specific blockchain type and at least one of a specific decentralized and/or distributed long-term storage type. The corresponding containers of the selection are orchestrated by a container orchestration framework 830 that results in the deployment, configuration, and management of a long-running blockchain service and a corresponding long-running decentralized and/or distributed long-term storage service. The services are designated to run as multiple nodes, or a cluster, where the auto-discovery and consensus mechanisms are utilized to perform decentralized and/or distributed computing tasks.

The network configurations of the blockchain deployment can be configured at genesis and modified later to extend the network. The network may extend to all areas under management and accessible by a network. Therefore, deployments can exist at multiple locations very similar to a private cloud 850.

What is claimed is:

1. A graphical data structure that enables the discovery and formation of deep links for queries of data stored on blockchain and smart contract platforms, particularly data from remote embedded devices within a data fabric, the data structure comprising:
a device model executable by a computer processor to perform computations on the data in accordance with established methods for performing computations on data stored in a blockchain;
an interface definition with a connection to an autonomous, low-code, or no-code system, which automates or semi-automates changes relating to the creation, management, and removal of smart contract interface definitions, translated to blockchain-specific languages, and;
a non-fungible token defined from a templated and minimal set of strict interface definitions in intermediate representation.

2. The data structure of claim 1, wherein deep links can be applied to the specification of a single non-fungible token at creation or runtime.

3. The data structure of claim 1, wherein deep links can be applied to multiple non-fungible tokens that each point to relationships and associations between records.

4. The data structure of claim 1, wherein the autonomous system can be any local or remote process that can autonomously apply data links, data relations, data repair, and associated data methodologies for acquisition, storage, or analysis with or without artificial intelligence and machine learning including deep learning methodologies.

5. The data structure of claim 1, wherein the device model specifies a remote embedded device or procedure with a finite set of inputs and outputs.

6. The data structure of claim 1, wherein the low- or no-code interface includes a domain specific language.

7. The data structure of claim 1, wherein the representations of smart contract implementations in the low- or no-code interface are in an intermediate form that can be specified to result in the specific code of a smart contract for a corresponding blockchain.

8. A universal adapter of claim 1 that implements a novel or custom method of interfacing edge computing gateways, databases, and blockchain data fabric infrastructure to perform computations based on data stored and accessible by the blockchain, comprising:
at least one web3 client for communication with one or more blockchains;
at least one peer-to-peer network storage interface, such as an IPFS client;
a library of connectors to leading edge computing gateways and pubsub brokers, and;
a library of connectors to leading databases commonly found in existing or legacy data fabrics.

9. The method of claim 8, wherein the interface definitions specify a finite set of inputs and outputs for the connection.

10. The method of claim 8, wherein the web3 client corresponds to a specific blockchain from a selection of clients and blockchains.

11. The method of claim 8, wherein the web3 client corresponds to the transactions of metadata and pointers to records in the peer-to-peer network storage.

12. The method of claim 8, wherein the peer-to-peer network storage stores the intermediate interfaces and device models of the system.

13. The method of claim 8, wherein the peer-to-peer network storage stores the payload data from remote embedded devices and processes of data fabric operations.

14. A method for cloud-native deployment of a blockchain and parallel peer-to-peer storage components, the method comprising containerizing the blockchain and storage components using containerization techniques and using a low or no-code interface to configure and manage the network through container orchestration tools, thereby providing a flexible and scalable deployment of the blockchain data fabric infrastructure with cloud computing benefits such as scalability, reliability, and resiliency, and a decentralized and resilient data storage solution through the parallel peer-to-peer storage strategy.

15. The method of claim 14, wherein the deployment of the blockchain data fabric infrastructure includes multiple blockchain nodes.

16. The method of claim 14, wherein the deployment of the blockchain data fabric infrastructure includes multiple peer-to-peer network storage nodes.

17. The method of claim 14, wherein the deployment of the blockchain data fabric infrastructure can be extended to connected networks of a specific location.

18. The method of claim 14, wherein the deployment of the blockchain data fabric infrastructure is applied to standard appliances and devices including virtual machines and servers of a specific location.
